(19) United States
(12) Patent Application Publication
(10) Pub. No.: US 2023/0206505 A1
(43) Pub. Date: Jun. 29, 2023

(54) METHOD OF VISUAL CONTENT COMMUNICATION IN AN ELECTRONIC DEVICE

(71) Applicant: SAMSUNG ELECTRONICS CO., LTD., Suwon-si (KR)

(72) Inventors: Abhishek SHARMA, Ponta Sahib (IN); G Abhishek KUMAR, Kalkaji (IN); Shailja SHARMA, Noida Extension (IN); Anil Kumar SAINI, Noida (IN); Ashutosh RAGHUVANSHI, Ramgarh (IN)

(73) Assignee: SAMSUNG ELECTRONICS CO., LTD., Suwon-si (KR)

(21) Appl. No.: 18/105,637

(22) Filed: Feb. 3, 2023

Related U.S. Application Data
(63) Continuation of application No. PCT/KR2022/017795, filed on Nov. 11, 2022.

(30) Foreign Application Priority Data
Dec. 29, 2021 (IN) 202141061636

(51) Int. Cl. G06T 7/90; G06V 10/25; G06V 10/60; G06T 7/13

(52) U.S. Cl. CPC G06T 7/90; G06V 10/25; G06V 10/60; G06T 7/13

(57) ABSTRACT

A method of visual content communication includes: receiving, multimedia data from a multimedia source; identifying, a first set of pixels from among a plurality of pixels of the multimedia data in a YCbCr color space based on information in the plurality of pixels; selecting, a second set of pixels from among the first set of pixels based on a luminance value and an inter-pixel distance of each pixel of the first set of pixels; generating, metadata for the second set of pixels based on an auxiliary content, wherein the auxiliary content is to be added in the multimedia data; modifying, at least one of a Cb component or a Cr component of the second set of pixels using a modification factor based on the metadata; and transmitting, to an electronic device, the multimedia data in an RGB color space with the modified second set of pixels using visible light communication.

### CROSS-REFERENCE TO RELATED APPLICATION(S)

This application is a bypass continuation of PCT International Application No. PCT/KR2022/017795, filed on Nov. 11, 2022, which is based on and claims priority to Indian Patent Application No. 202141061636, filed on Dec. 29, 2021, in the Indian Patent Office, the disclosures of which are incorporated herein by reference in their entireties.

### BACKGROUND

### 1. Field

The disclosure relates to visual communication, and more specifically, to a method of visual content communication in an electronic device.

### 2. Description of Related Art

Light fidelity (Li-Fi) is a light communication system which is capable of transmitting data over visible light. In the related art, only light emitting diode (LED) lamps are used for transmission of the data over the visible light.

A visible light communication (VLC) is a data communication technique which uses the visible light with a frequency spectrum between 400 and 800 Terahertz (THz) for transmission of the data. The VLC is possible using an electronic device which includes a display for example, televisions, personal computers, smartphones, smart watches, and smart screens or display devices. The VLC data may be imaged using a camera.

In an example scenario, a video stream is encoded with visible light information, and the visible light information is further transmitted as visible light using the display. The receiver is the electronic device that captures the visible light information using an image sensor, decodes the visible light information to the video stream and displays the video stream on the screen of the receiver.

However, usage of the related art displays such as an active-matrix organic light-emitting diode (AMOLED) display for transmission of additional data using the visible light has several limitations due to a high RGB (red, green, and blue) pixel density of the additional data and continuous flickering of the additional data. One of the limitations is that the related art displays cannot provide dynamically changing augmented data such as advertisements and promotional offers. Another limitation is that the related art displays may communicate the visible light information to the receiver up to a limited distance. Yet another limitation of the related art is that critical information may lost while reading the additional data using the image sensor (e.g. camera). Yet another limitation of the related art displays is that the high RGB pixel density of the additional data creates interferences with neighboring pixels while sending the additional data via the visible light.

Another problem with the related art displays is that, if blinking of the AMOLED display is below a critical clicker frequency of 100 Hz, then human eyes perceives the blinking as brightness variation which creates annoying flickering effect to the human eyes. Moreover, when a high dynamic range (HDR) content is played over the display, the receiver such as the smartphone are unable to read the data from the display.

### SUMMARY

Provided are a method and an electronic device for focusing on optical camera communication for augmenting data into an existing visual signals by interchangeably selecting Blue Chrominance (Cb)/Red Chrominance (Cr) components

Further, provided is a method of transmitting and receiving augmented data using visible light communication, where the data is augmented by adding auxiliary data in the original data.

Further still, provided is a method of receiving the augmented data over visible light communication by identifying a region of interest (ROI), identifying, a display area in the ROI based on a change in luminance in consecutive frames; determining metadata information from the edges of the determined display area, based on a predefined modification factor of a modulation of only the Cb component, and extracting modified second set of pixels based on the modification factor and the metadata.

Further, provided is are a method and an electronic device in which an optical zoom of a camera is used to ensure each pixel is captured properly in the visible light.

In accordance with an aspect of the disclosure, a method of visual content communication, includes: receiving, by a first electronic device, multimedia data from a multimedia source; identifying, by the first electronic device, a first set of pixels from among a plurality of pixels of the multimedia data in a YCbCr color space based on information in the plurality of pixels; selecting, by the first electronic device, a second set of pixels from among the first set of pixels based on a luminance value and an inter-pixel distance of each pixel of the first set of pixels; generating, by the first electronic device, metadata for the second set of pixels based on an auxiliary content, wherein the auxiliary content is to be added in the multimedia data; modifying, by the first electronic device, at least one of a Cb component or a Cr component of the second set of pixels using a modification factor based on the metadata; and transmitting, by the first electronic device to a second electronic device, the multimedia data in an RGB color space with the modified second set of pixels using visible light communication.

The method may further include: capturing, by a camera of the second electronic device, a set of continuous image frames, transmitted over visible light using optical zoom capabilities of the second electronic device, from the multimedia data with the modified second set of pixels; identifying, by the second electronic device, a region of interest (ROI) from the continuous image frames and obtaining ROI data in the RGB color space; identifying, by the second electronic device, a display area in the ROI based on a change in luminance in consecutive frames; converting, by the second electronic device, data in the display area from the RGB color space to the YCbCr color space; determining, by the second electronic device, the metadata from edges of the determined display area, based on a predefined modification factor of a modulation of the Cb component; and extracting, by the second electronic device, the modified second set of pixels based on the modification factor and the metadata by comparing at least one of the Cb component or the Cr component of respective pixels in subsequent frames.

The identifying the first set of pixels may include: determining, by the first electronic device, the information in the plurality of pixels of a multimedia data; excluding, by the first electronic device, from the multimedia data: pixels of the multimedia data having both the Cb component and Cr component outside the modulation threshold range, pixels of the multimedia data that are part of a moving object in successive multimedia frames, or pixels of the multimedia data that are part of an edge of an object in the multimedia data; comparing, by the first electronic device, values of the Cb component and the Cr component for remaining pixels of the multimedia data other than the excluded pixels; and identifying, by the first electronic device, the pixels having a value of the Cb component greater than a value of the Cr component as a first set of Cb component pixels; and identifying, by the first electronic device, the pixels having the value of the Cr component greater than the value of the Cb component as a first set of Cr component pixels.

The selecting the second set of pixels may include: determining, by the first electronic device, the luminance value of each pixel in the first set of Cr component pixels and the first set of Cb component pixels; selecting, by the first electronic device, intermediate pixels from among the first set of Cr component pixels and the first set of Cb component pixels having a neighboring cell with a luminance value less than a threshold luminance value; and selecting, by the first electronic device, the second set of pixels from among the intermediate pixels based on the inter-pixel distance.

The selecting the second set of pixels based on the inter-pixel distance may include: determining, by the first electronic device, the inter-pixel distance of each intermediate pixel by checking nearest pixels in a Cr component list or a Cb component list; and selecting, by the first electronic device, a predefined number of pixels having a maximum inter-pixel distance as the second set of pixels.

The generating the metadata for the second set of pixels may include: determining, by the first electronic device, a plurality of information sets in the auxiliary content; mapping, by the first electronic device, pixels from the second set of pixels to the plurality of information sets in the auxiliary content; and generating, by the first electronic device, the metadata indicating the mapped pixels for the plurality of information sets, wherein the metadata includes information about pixel coordinates for each information set of the auxiliary content and the at least one of the Cb component or the Cr component to be modified.

The modifying the at least one of the Cb component or the Cr component of the second set of pixels using the modification factor may include: converting, by the first electronic device, the auxiliary content into binary bits; obtaining, by the first electronic device, a predefined modification factor for modifying the metadata of the second set of pixels; and modifying, by the first electronic device, the metadata of the second set of pixels by modifying one of the Cb component or the Cr component using the modification factor based on the metadata.

The determining, by the second electronic device, the metadata from the edges of the determined display area may include: extracting, by the second electronic device, the Cb component and the Cr component of the pixels from the ROI; obtaining, by the second electronic device, the predefined modification factor; determining, by the second electronic device, a change in the Cb component in successive frames of the ROI based on the modification factor; and extracting, by the second electronic device, the metadata from the edges of the determined display area based on the change in the Cb component in successive frames of the ROI.

The method may further include: generating, by the second electronic device, a user association map based on a plurality of interaction of a user with a plurality of entities; filtering, by the second electronic device, the modified second set of pixels to obtain user specific data based on the user association map; selecting, by the second electronic device, at least one format and at least one medium for displaying the user specific data; and displaying, by the second electronic device, the user specific data on the at least one medium.

The at least one medium may be an Internet of Things (IoT) device that selected using an IoT state map.

According to an aspect of the disclosure, an electronic device for visual content communication, includes: a memory storing instructions; a processor configured to execute the instructions to: receive multimedia data from a multimedia source, and identify a first set of pixels from a plurality of pixels of the multimedia data in a YCbCr color space based on information in the plurality of pixels, select a second set of pixels from among the first set of pixels based on a luminance value and an inter-pixel distance of each pixel from the first set of pixels, generate a metadata for the second set of pixels based on an auxiliary content, wherein the auxiliary content is to be added in the multimedia data, and modify a Cb component of the second set of pixels using a modification factor based on the metadata; and a communicator configured to transmit the multimedia data in an RGB color space with the modified second set of pixels to a display device using visible light communication.

The processor may be further configured to execute the instructions to: determine the information in the plurality of pixels of the multimedia data, exclude from the multimedia data: pixels of the multimedia data having both the Cb component and a Cr component outside a modulation threshold range, pixels of the multimedia data that are part of a moving object in successive multimedia frames, or pixels of the multimedia data that are part of an edge of an object in the multimedia data, compare values of the Cb component and the Cr component for remaining pixels of the multimedia data other than the excluded pixels, and identify pixels having a value of the Cb component greater than a value of the Cr component as a first set of Cb component pixels, and identify pixels having the value of Cr component greater than the value of the Cb component as a first set of Cr component pixels.

The processor may be further configured to execute the instructions to: determine the luminance value of each pixel of the first set of Cr component pixels and the first set of Cb component pixels, select intermediate pixels from among the first set of Cr component pixels and the first set of Cb component pixels having a neighboring cell with a luminance value less than a threshold luminance value, determine an inter-pixel distance of each intermediate pixel by checking nearest pixels in a Cr component list or a Cb component list, and select a pre-defined number of pixels having a maximum inter-pixel distance as the second set of pixels.

The processor may be further configured to execute the instructions to: determine a plurality of information sets in the auxiliary content, map pixels from the second set of pixels to the plurality of information sets in the auxiliary content, and generate the metadata indicating the mapped pixels for the plurality of information sets, wherein the metadata includes information about pixel coordinates for each information set of auxiliary content.

The processor may be further configured to execute the instructions to: convert the auxiliary content into binary bits, obtain a predefined modification factor for modifying the metadata of the second set of pixels, and modify the metadata of the second set of pixels by modifying one of the Cb component or the Cr component using the modification factor.

According to an aspect of the disclosure, an electronic device for visual content communication, the electronic device includes: a camera configured capture a set of continuous image frames transmitted over visible light; a memory storing instructions; and a processor configured to execute the instructions to: identify a region of interest (ROI) from the continuous image frames, obtain the ROI data in an RGB color space, identify a display area in the ROI based on a change in luminance in consecutive frames, convert data in the display area from the RGB color space to a YCbCr color space, and determine metadata information from edges of the determined display area, based on a predefined modification factor of a modulation of a Cb component, and extract a modified second set of pixels based on the modification factor and the metadata information.

The processor may be further configured to execute the instructions to: extract the Cb component and a Cr component of pixels from the ROI, obtain the predefined modification factor, determine a change in the Cb component and the Cr component in successive frames of the ROI based on the modification factor, and extract the metadata information from the edges of the determined display area based on the change in the Cb component and the Cr component in successive frames of the ROI.

The processor may be further configured to execute the instructions to: generate a user association map based on a plurality of interactions of a user with a plurality of entities, filter the modified second set of pixels to obtain user specific data based on the user association map, select at least one format and at least one medium for displaying the user specific data, and display the user specific data on the at least one medium.

The at least one medium may be an Internet of Things (IoT) device that is selected using an IoT state map.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a block diagram of a first electronic device for providing visual content communication, according to an embodiment;

FIG. 1B is a block diagram of a second electronic device, for providing visual content communication, according to an embodiment;

FIG. 2A is a block diagram of a pixel selector for selecting a first set of pixels, according to an embodiment;

FIGS. 2B and 2C are schematic diagrams illustrating pixel selection by the pixel selector, according to an embodiment;

FIG. 3A is a block diagram of the spatial content manager for generating metadata, according to an embodiment;

FIGS. 3B, 3C, 3D, and 3E—are schematic diagrams illustrating an example of selection of the second set of pixels by the interference preventer, according to an embodiment;

FIG. 4A is a block diagram of a data augmenter for augmentation of the original data, according to an embodiment;

FIGS. 4B and 4C are schematic diagrams illustrating modification of Cb and/or Cr components to include auxiliary data, according to an embodiment;

FIGS. 4D and 4E are schematic diagram illustrating augmentation of a metadata and the transmitter side, according to an embodiment;

FIG. 5A is a block diagram, illustrating an ROI detector for extracting the ROI, according to an embodiment;

FIG. 5B is a schematic diagram, illustrating an example edge detection scenario, according to an embodiment;

FIG. 6A is a block diagram, illustrating a content extractor for extracting desired contents, according to an embodiment;

FIG. 6B is a schematic diagram, illustrating examples of identification of modified content, according to an embodiment;

FIG. 7 is a block diagram of a data selection engine for selection of user specific data, according to an embodiment;

FIG. 8 is a block diagram of an enhanced data presenter for selecting a display device for displaying augmented data, according to an embodiment;

FIG. 9A is a flow diagram, illustrating a method for visual content communication from a transmitter side, according to an embodiment;

FIG. 9B is a flow diagram, illustrating a method for visual content communication from a receiver side, according to an embodiment;

FIG. 9C is a flow diagram, illustrating a method for visual content communication from a transmitter side, according to an embodiment;

FIG. 10 is a schematic diagram, illustrating an example airport scenario of the visual light communication, according to an embodiment;

FIG. 11 is a schematic diagram, illustrating an example family hub scenario of the visual light communication, according to an embodiment; and

FIG. 12 is a schematic diagram illustrating an example scenario of a monument display according to an embodiment;

FIG. 13A is a schematic diagram illustrating problems in a display at an airport;

FIG. 13B is a schematic diagram illustrating a solution to the problem illustrated in FIG. 13A, according to an embodiment;

FIGS. 14A, 14B, and 14C are schematic diagrams illustrating a shopping scenario indicating different offers, according to an embodiment;

FIG. 15 is a schematic diagram, illustrating an example scenario, according to an embodiment; and

FIG. 16 is a schematic diagram, illustrating an example scenario, according to an embodiment.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments may be combined with one or more other embodiments to form new embodiments. The term “or” as used herein, refers to a non-exclusive or, unless otherwise indicated. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

In an embodiment, the proposed method and the electronic device discloses augmenting a multimedia data and sending the augmented data using visible light communication. Further, a camera of another electronic device, captures the augmented data transmitted over the visible light.

Hereinafter, embodiments of the present disclosure will be described in detail with reference to the accompanying drawings, where similar reference characters denote corresponding features consistently throughout.

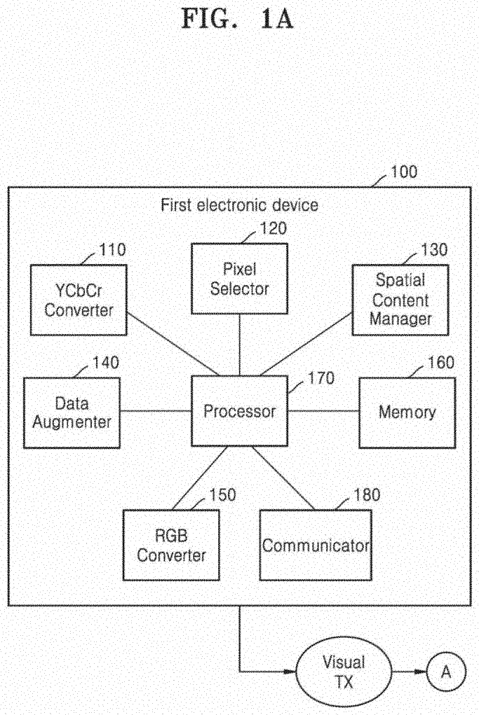

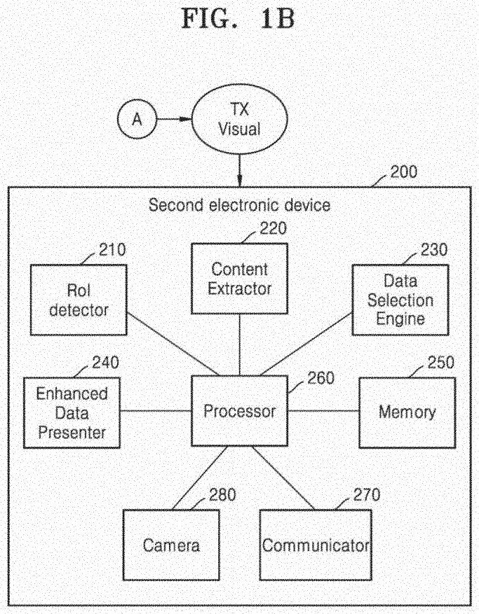

FIG. 1A is a block diagram of a first electronic device for providing visual content communication, according to an embodiment. FIG. 1B is a block diagram of a second electronic device, for providing visual content communication, according to an embodiment.

The first electronic device 100 and the second electronic device 200 may be, for example, but not limited to, a mobile device, a cellular phone, a smart phone, a smart display device, a personal digital assistant (PDA), a tablet computer, a laptop computer, an Internet of things (IOT) device, an artificial intelligence (AI) device, a virtual assistant (VA) device, a wearable device or the like.

In an embodiment, the first electronic device 100 operates as a transmitter, which encodes an input signal and transmits over multiple visible light signals, whereas the second electronic device 200 operates as a receiver which receives the encoded input signal and further decodes the input signal for displaying on a screen of the second electronic device 200 or any other electronic device comprising the screen.

The first electronic device 100 comprises a YCbCr convertor 110, a pixel selector 120, a spatial content manager 130, a data augmenter 140, a RGB convertor 150, a memory 160, a processor 170 and a communicator 180.

The second electronic device 200 comprises a Region of Interest (ROI) detector 210, a content extractor 220, a data selection engine 230, an enhanced data presenter 240, a memory 250, a processor 260 a communicator 270 and a camera 280.

The YCbCr convertor 110, the pixel selector 120, the spatial content manager 130, the data augmenter 140, and the RGB convertor 150 of the first electronic device 100 are implemented by the processor 170 or separate processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

The ROI detector 210, the content extractor 220, the data selection engine 230, and the enhanced data presenter 240 of the second electronic device 200 are implemented by the processor 260 or separate processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

In an embodiment, the first electronic device 100 receives an input from a multimedia source. The input is a multimedia data such as an image, a video and the like. After receiving the input, the YCbCr convertor 110 checks whether the input is in a RGB format or a YCbCr format. If the input is in the RGB format, then the YCbCr convertor 110 converts the input into the YCbCr format and sends to the pixel selector 120. If the input is in the YCbCr format, then the YCbCr convertor 110 directly sends the input as it is to the pixel selector 120.

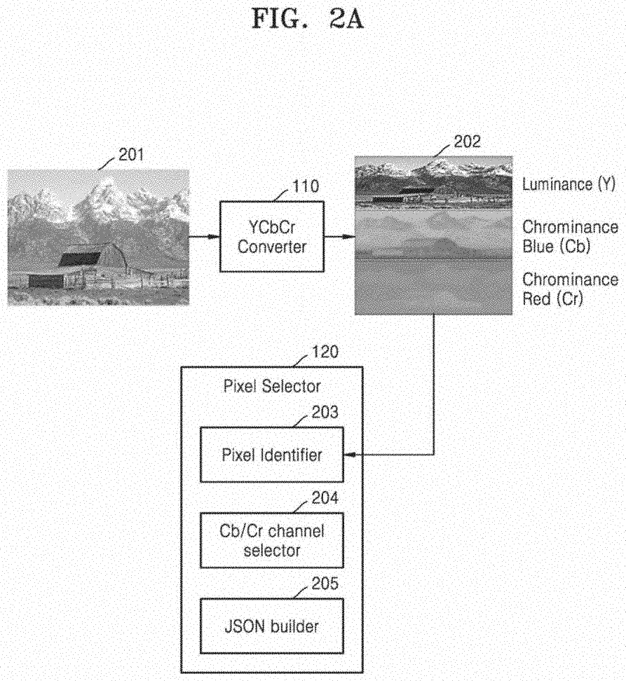

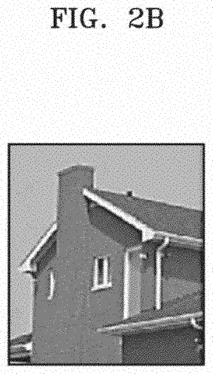

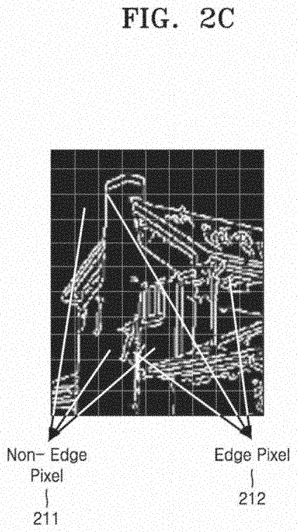

After receiving the input signal in YCbCr format, the pixel selector 120 selects a set of pixels for whom a modification in a Cb component and/or a Cr component does not distort the multimedia input data. Further, the pixel selector 120 selects pixels from a plurality of pixels of the multimedia data based on a dominating factor from the Cb component and the Cr component, and generates a list of pixels comprising dominating Cb component and another list of pixels comprising dominating Cr component. The selected pixels are termed as a first set of pixels in the present embodiment. Finally, the pixel selector 120 converts the first set of pixels into a JavaScript Object Notation (JSON) format and sends to the spatial content manager 130. The functioning of the pixel selector 120 is explained in detail with examples in FIG. 2A.

The spatial content manager 130 upon receiving the selected pixels in the JSON format, further filters the first set pixels to obtain a second set of pixels. The second set of pixels are obtained based on an inter-pixels distance and a luminance value of the first set of pixels in the first set to ensure transmission of the multimedia data to a maximum distance with minimal inter-pixel interference. Further, the spatial content manager 130 generates metadata based on an auxiliary content and the second set of pixels. The auxiliary content is the content to be added in the multimedia data for enhancement. The auxiliary content comprises a plurality of information sets. The spatial content manager 130 maps pixels from the second set of pixels to the plurality of information set in auxiliary data for obtaining the metadata.

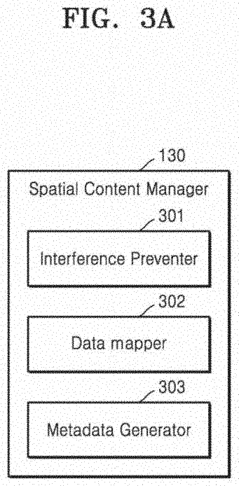

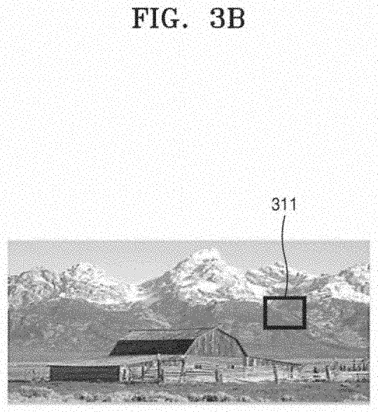

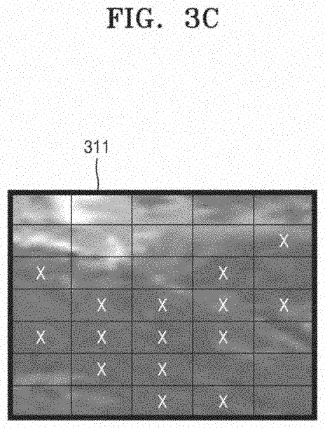

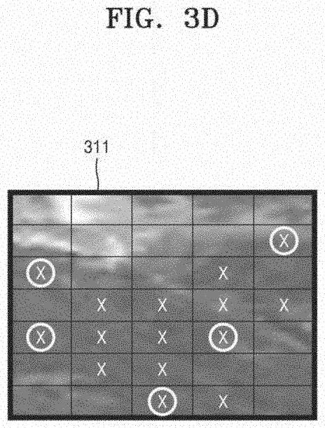

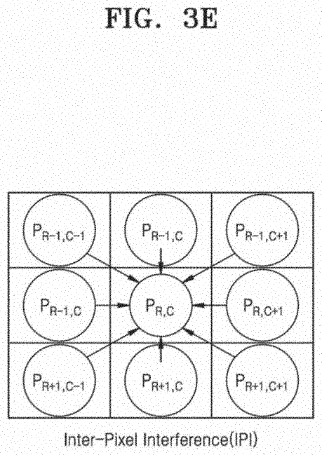

The metadata indicates the mapped pixels coordinates each information set and the component (Cb or Cr) to be modified for adding the auxiliary content. The metadata and the auxiliary content is sent to the data augmenter 140 by the spatial content manager 130. The functioning of the spatial content manager 130 is explained in detail with examples in FIGS. 3A, 3B, 3C, 3D, and 3E.

The data augmenter 140 converts the auxiliary content into a binary bits format and determines a modification factor for modifying the Cb/Cr component. The Cb/Cr component are modified for addition of the auxiliary content. The data augmenter 140 then modifies the mapped pixels with the different information sets in the auxiliary content by modifying the Cb/Cr component using the modification factor. Finally, the data augmenter 140 sends the Y component and the modified Cb/Cr component to the RGB convertor 150.

The RGB convertor 150 converts the Y component and the modified Cb/Cr component to the RGB format for transmission over the visible light signals.

The memory 160 stores instructions to be executed by the processor 170 for the visual content communication. In an embodiment, the memory 160 may include non-volatile storage elements. Examples of such non-volatile storage elements may include magnetic hard discs, optical discs, floppy discs, flash memories, or forms of electrically programmable memories EPROM) or electrically erasable and programmable (EEPROM) memories. In addition, the memory 160 may, in some examples, be considered a non-transitory storage medium. The term “non-transitory” may indicate that the storage medium is not embodied in a carrier wave or a propagated signal. However, the term “non-transitory” should not be interpreted that the memory 160 is non-movable. In certain examples, a non-transitory storage medium may store data that may, over time, change (e.g., in random access memory (RAM) or cache). The memory 160 may be an internal storage or it may be an external storage unit of the electronic device 100, a cloud storage, or any other type of external storage.

In an embodiment, the processor 170 communicates with the memory 160, the communicator 180, the YCbCr convertor 110, the pixel selector 120, the spatial content manager 130, the data augmenter 140, and the RGB convertor 150. The processor 170 is configured to execute instructions stored in the memory 160 for providing personalized response. The processor 170 may include one or a plurality of processors, may be a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

In an embodiment, the communicator 180 is configured for communicating internally between internal hardware components and with external devices via one or more networks. The communicator 180 includes an electronic circuit specific to a standard that enables wired or wireless communication.

The second electronic device 200 receives, the modified multimedia data transited over the visible light signals by the first electronic device 100.

The camera 280 of the second electronic device 200 captures the modified input as a set of continuous image frames and sends the continuous image frames to the ROI detector 210.

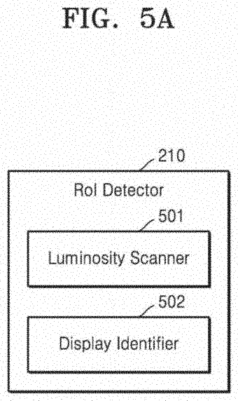

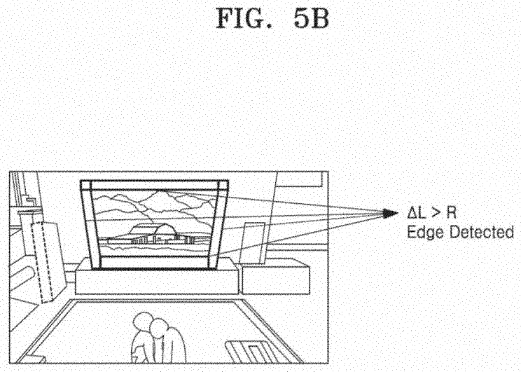

The ROI detector 210 determines an actual ROI from each image frame that needs to be scanned to get the required data and also metadata boundaries. In an embodiment, the ROI detector 210 determines a luminosity of all the pixels captured between successive frames and compares the luminosity with a luminosity factor. Based on the comparison, coordinates of the ROI is detected. The ROI detector 210 sends the coordinates of the ROI to the content extractor 210. The functioning of the ROI detector 210 is explained in detail with examples in FIG. 5.

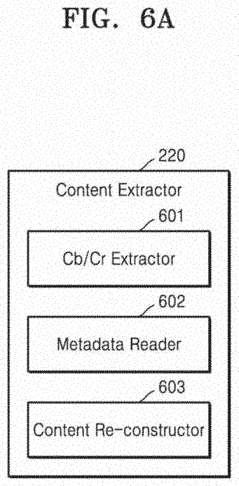

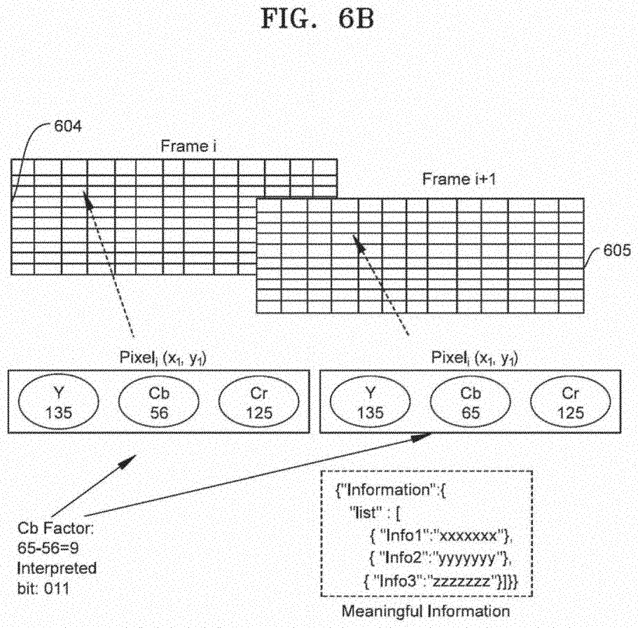

The content extractor 220 extracts the Cb component and the Cr component of all the pixels from the ROI of the successive frame. Further, the content extractor 220 extracts metadata information of content blocks from a border of the ROI and identifies a location of the content block from the metadata. Based on the content block and the metadata, the content extractor 220 restructures the content into meaningful data and sends to the data selection engine 230. The functioning of the content extractor 220 is explained in detail with examples in FIGS. 6A and 6B.

The data selection engine 230 is responsible for personalizing the information obtained from the content extractor 220 as per a user association map. The user association map gets contextual information from a user device and calculates association weights as per the user behavior.

Further, the data selection engine 230 selects different content for each individual user based on the corresponding user association mappings. Thus the data selection engine 230 determines data specific to the user.

The enhanced data presenter 240 formats the content from the data selection engine 230 into a desired format. A personalized template is used by the enhanced data presenter 240 for displaying the content. The enhanced data presenter 240 is also responsible for selecting a best accessible mode for the user to display the content. The enhanced data presenter 240 is also responsible for customization of a format content type and language for better understanding.

The memory 250 stores instructions to be executed by the processor 260 for visual content communication. In an embodiment, the memory 250 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 250 may, in some examples, be considered a non-transitory storage medium. The term “non-transitory” may indicate that the storage medium is not embodied in a carrier wave or a propagated signal. However, the term “non-transitory” should not be interpreted that the memory 250 is non-movable. In certain examples, a non-transitory storage medium may store data that may, over time, change (e.g., in Random Access Memory (RAM) or cache). The memory 250 may be an internal storage or it may be an external storage unit of the electronic device 100, a cloud storage, or any other type of external storage.

In an embodiment, the processor 260 communicates with the memory 250, the communicator 270, the ROI detector 210, the content extractor 220, the data selection engine 230, and the enhanced data presenter 240 of the second electronic device 200. The processor 260 is configured to execute instructions stored in the memory 250 for providing personalized the response. The processor 260 may include one or a plurality of processors, may be a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

In an embodiment, the communicator 270 is configured for communicating internally between internal hardware components and with external devices via one or more networks. The communicator 270 includes an electronic circuit specific to a standard that enables wired or wireless communication.

Thus as seen above, the proposed method and the first electronic device 100 and the second electronic device 200 provides efficient visual content communication.

Although the FIG. 1 shows various hardware components of the electronic device 100 and 200 but it is to be understood that other embodiments are not limited thereon. In some embodiments, the electronic device 100 and 200 may include less or more number of components. Further, the labels or names of the components are used only for illustrative purpose and does not limit the scope of the disclosure. One or more components may be combined together to perform same or substantially similar function for visual content communication.

FIG. 2A is a block diagram of the pixel selector 120 for selection of the first set of pixels, according to an embodiment.

As seen in FIG. 2A, the pixel selector 120 takes input from the YCbCr convertor 110 for selecting the pixels. The input to the YCbCr convertor 110 is a raw image 201 is the RGB format. The YCbCr convertor 110 converts the input raw image 201 into the YCbCr format 202 and forwards to the pixel selector 120. In an embodiment, the input signal may be in the YCbCr format and is directly forwarded to the pixel selector 120.

The human visual system (HVS) has a highest visual acuity to distinguish changes of color signal under mid-gray background. Pixels with mid-gray chrominance (e.g., Y-128, Cb-128, Cr-128) are neglected for data augmentation/modification. The Y component of a pixel helps in predicting an edge of an object/content. AY is a difference in the luminosity of adjacent pixels should be less than threshold value T. The dynamic pixel selection picks only those pixel whose Cb/Cr component may be modified for a defined threshold value for a content-type. The dynamic pixel selection ensures that the changes will be imperceptible and the image/color distortion is negligible.

The pixel selector 120 comprises a pixel identifier 203, a Cb/Cr channel selector 204, and a JSON builder 205. The pixel identifier 203 receives the input in YCbCr format.

Upon receiving the input in the YCbCr format, the pixel identifier 203 selects the first set of pixels whose modification in Cb/Cr component does not distort color or objects in the original image (input). In an embodiment, while selecting the first set of pixels, the pixel identifier 203 identifies pixels which does not fulfils a set of eligibility criteria to be selected in the first set of pixels. The pixel identifier 203 identifies the pixels for which:

a) pixels which are not in plausible modulation range (50-100, 150-200) of Cb (blue chrominance)/Cr (red chrominance) component. The Cb component and/or the Cr component values of the pixels which are not in range (50-100, 150-200) respectively,

b) pixels whose Cb/Cr value delta from previous frame is more than a threshold K for the defined content. (Difference between values of the Cb component and/or the Cr component in successive frames is greater than K (Δ Cb/Δ Cr in successive frame>K)),

c) pixel is actively part of a foreground moving object in successive frames, and

d) pixels are part of an edge of any object. The Y Component of a pixel helps in predicting edge of the object. Further, pixels having ΔY, a difference in luminance of adjacent pixels is more than threshold value T (ΔY>T) are also excluded.

The identified pixels which comes under any one or more categories mentioned above (a-d) are excluded by the pixel identifier 203 and the remaining pixels are forwarded to the Cb/Cr channel selector 204.

The Cb/Cr channel selector 204 generate two different lists of pixels. One list of pixels includes pixels in which Cb is the dominating component and the other list of pixels includes pixels in which Cr is the dominating component. The selected pixels in the Cr list and the Cb list are termed as the first set of pixels in the present embodiment. The dominant component (Cb or Cr) in the selected pixel is identified to ensure highest imperceptibility.

The first set of pixels is then sent to the JSON builder 205. Finally, the JSON builder 205 converts the first set of pixels into a JavaScript Object Notation (JSON) format and sends to the spatial content manager 130.

FIGS. 2B and 2C are schematic diagram illustrating pixel selection, according to an embodiment.

FIG. 2B is a picture of a house. FIG. 2C is illustrates the edge pixels 211 and non-edge pixels 212 of the picture. The edge pixels 211 are discarded, whereas the non-edge pixels 212 do not come under excluded categories and are selected by the pixel selector 120.

FIG. 3A is a block diagram of the spatial content manager 130 for generating metadata, according to an embodiment.

The spatial content manager 130 takes the first set of pixels and auxiliary data (auxiliary content) as the input. The auxiliary data is the data to be added to the original input to the electronic device 100. In an embodiment, the auxiliary data is specific to the user of the electronic device 100 and 200. The original input is augmented/modified using the auxiliary data.

The spatial content manager 130 comprises an interference preventer 301, a data mapper 302, and a metadata generator 303.

The interference preventer 301 takes the second set of pixels and the auxiliary data as the input. The interference preventer 301 is responsible for further selecting the second set of pixels from the first set, such that each pixel in the second set of pixels have the maximum inter-pixel distance based on a volume of the auxiliary data. Having pixels with maximum inter-pixel distance ensures transmission of data to maximum distance with minimal interference.

The data mapper 302 is responsible for mapping each selected pixel in the second set of pixels to the information set in the auxiliary data. In an embodiment, the auxiliary data comprises information set. The data mapper 302 assigns/maps each pixels from the second set of pixels to different information set.

Once the data mapping is performed, the metadata generator 133 generates the metadata. The metadata provides information about pixel coordinates of each pixel mapped to the information set of the auxiliary data. Further, the metadata also provides information about the Cb component and the Cr component for modification of the mapped pixels for introducing/adding the auxiliary data in the original input.

The metadata generator 133 sends the auxiliary data and the metadata to the data augmenter 140 for modification of the Cb/Cr component.

FIGS. 3B, 3C, 3D, and 3D are schematic diagrams, illustrating an example of selection of the second set of pixels by the interference preventer 131, according to an embodiment.

FIG. 3B shows an input image with a block 311 for understanding purpose. FIG. 3B2 shows the block 311 comprising pixels selected to be in the first set. The X in FIG. 3C shows the selected pixel data for the block 311 of FIG. 3B. For the present embodiment, the number of pixels selected to be in first set is assumed to be 100.

The interference preventer 131 performs two steps for selecting the second set of pixels. In the first step, the interference preventer 131 determines a number of pixels to be selected for the second set of pixels. The interference preventer 131 also determines the modification factor and minimum pixels per frame. The total pixel modification is given by Equation 1 and the minimum pixels per frame is given by Equation 2. In Equation 2, C is the constant for the metadata.

$$Total Pixel Modification = \frac{Auxilliary Bits ( N )}{Modification Factor bits ( K )} \qquad Equation 1$$

$$Mini pixel per frame = \frac{Total Pixel Modifications}{Frame Rate} - C \qquad Equation 2$$

In the present embodiment, the number of pixels to be selected is 60 and hence at step 2, the interference preventer 131 selects 60 pixels for the second set such that each pixel has the maximum inter-pixel interference as seen in FIG. 3C.

FIG. 3E shows the 9 pixels and their interference distance. Thus in an example, out of these nine pixels, the required number of pixels are selected having maximum inter-pixel interference.

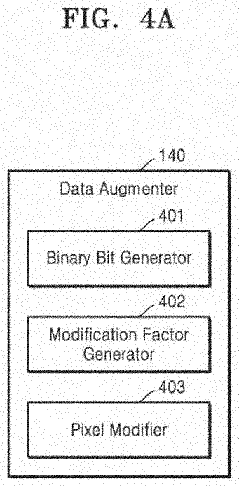

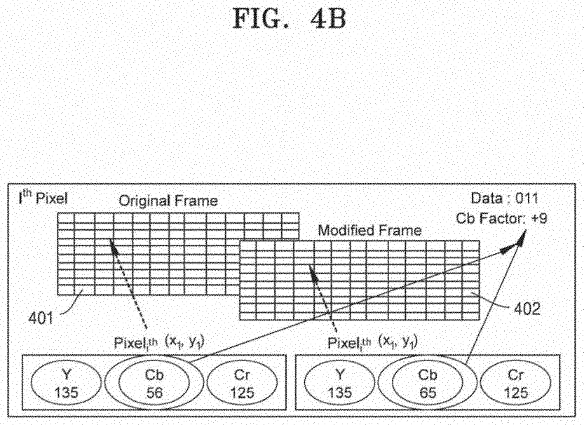

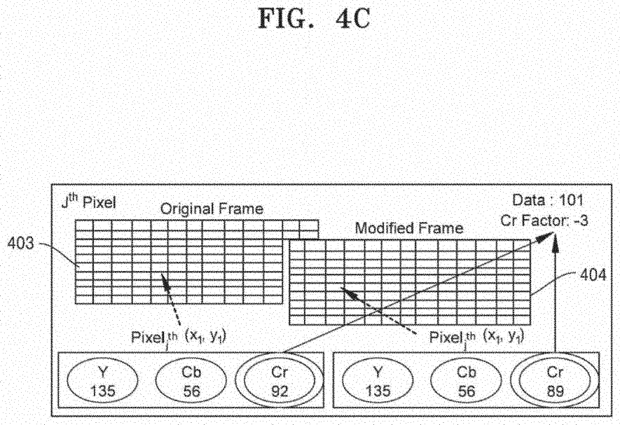

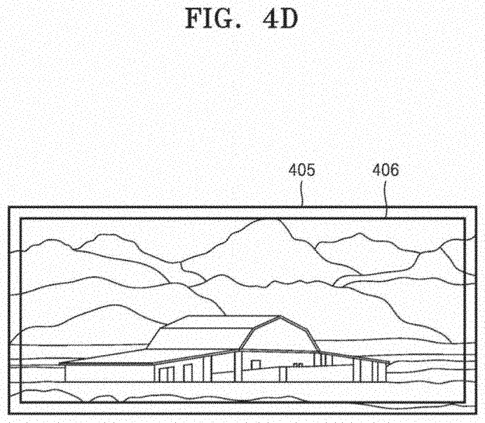

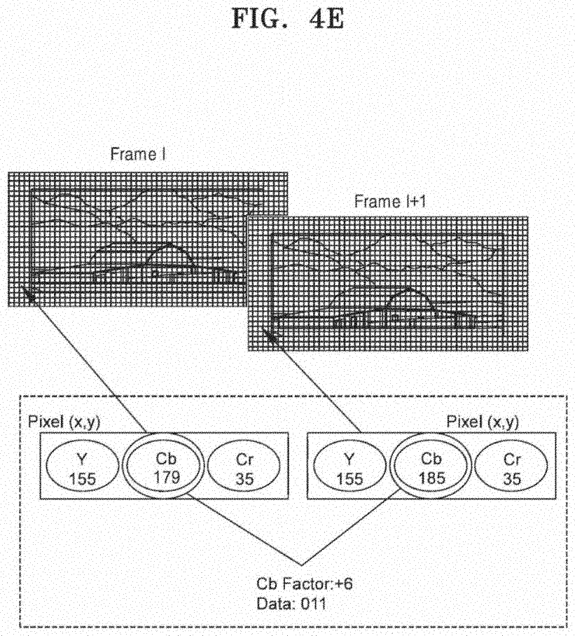

FIG. 4A is a block diagram of the data augmenter 140 for augmentation of the multimedia data, according to an embodiment.

In an embodiment, the metadata is augmented on the border of the display with fixed width. The Cb component of this border area pixels are modified with a predefined fixed modification factor common to all applications.

The data augmenter 140 is responsible for augmenting the original multimedia data with the auxiliary data based on a requirement of the user. The data augmenter 140 comprises a binary bit generator 401, a modification factor generator 402 and a pixel modifier 403.

The binary bit generator 141 takes the auxiliary data as input and converts the auxiliary data into binary bits. The auxiliary data in the binary bits format is sent to the modification factor generator 142. The modification factor generator 142 dynamically generates the modification factor by which a modulation is to be performed of the original input data.

The modification factor generator 142 is determined using Equation 3, where MSB is a most significant bit of the modification factor bits and LSB is the least significant bit of the modification factor bits. K indicates the modification factor bits. The modification factor is chosen such that the change in the original input data with the modification factor is imperceptible to a human eye but easily distinguished by a camera.

Based on a data length which needs to be added, and a mean chromaticity of the original input signal, the modification factor by which the Cb/Cr value of pixel(s) is tweaked to carry our data.

Modification Factor=Sign(MSB)*f*(Decimal Equivalent for K−1LSB) Equation 3
for bits with all 0s, Modification Factor (MF)=Sign*f*(2K−1) where f is a chromacity multiplier,
If K is determined to be 3 and f is 3, the Δ values of chromaticity are show in the table 1 given.

TABLE 1

| K | |
|---|---|
| bit representation | Modification |
| (K = 3) | Factor (MF) |
| 000 | (+1)*3*(3 + 1) = 12 |
| 001 | (+1)*3*1 = 3 |
| 010 | (+1)*3*2 = 6 |
| 011 | (+1)*3*3 = 9 |
| 100 | (−1)*3*0 = 0 |
| 101 | (−1)*3*1 = −3 |
| 110 | (−1)*3*2 = −6 |
| 111 | (−1)*3*(3) = −9 |

Once the modification factor is determined/generated, the pixel modifier 143 modifies the Cb component and the Cr component of the second set of pixels by the modification factor (MF).

Further, the modified data is sent to the RGB convertor 150 converts the modified data into RGB format. Thus the modified data is ready to be transmitted to the receiver side 200.

The modified signals are sent over visible light using visible light communication technique.

FIGS. 4B and 4C are schematic diagrams, illustrating the modification of Cb and/or Cr components to include auxiliary data, according to an embodiment.

As seen in FIG. 4B, 401 is an original frame as received by the second electronic device 200 and 402 is the modified frame with the auxiliary data. For a jth pixel, the value of the Y component is 135, Cb component is 56 and the Cr component is 125. In the present embodiment, the modified components into binary bits is 011 and hence the modification factor is +9. The Cb component is chosen to be modified based on the data augmenter 140 decision. Thus the modified Cb component is 56+9=65.

As seen in FIG. 4C, 403 is an original frame as received by the first electronic device 100 and 404 is a modified frame with the auxiliary data. For a jth pixel, the value of the Y component is 135, Cb component is 56 and the Cr component is 92. For the present embodiment the modification factor is −3. The Cr component is chosen to be modified based on the data augmenter 140 decision. Thus the modified Cb component is 92−3=89.

FIGS. 4D and 4E are schematic diagram illustrating augmentation of the metadata and the transmitter side, according to an embodiment.

As explained earlier, the metadata is augmented along the border of the display device with fixed pixel width and only the Cb component is modified for metadata augmentation. In FIG. 4D, a border width represented by an outer bounding box 405 and an inner bounding box 406 is 3 pixels, the modified component is Cb, the K parameter is 3, and a f factor is 3. The pixels available for the metadata (resolution 1980×1080) is 18324. Further, the data that may be augmented in a single frame is 54.9 Kb.

In an embodiment, the data rate is given by formula Data Rate=Screen Resolution×Frame Rate(60)×K, for K=5, Screen Resolution=1980×1080 & Frame rate=60, Throughput: ˜641 Mbit/s, 1.2 Gbit/s if both Cb/Cr are modified.

In an average case scenario, considering only 2/3 pixels are available for data augmentation (after considering IPI), throughput is ˜480 Mbit/s if only Cb or Cr is modified, If both Cb/Cr are modified, throughput of ˜960 Mbit/s may be achieved

FIG. 4E illustrates the transmitter side extraction of the augmented metadata.

The ROI detector 201 helps in detecting the borders of the digital display in the captured frame and the content extractor 220 extracts metadata from the border with a predefined fixed criteria.

After modification/augmentation of the original input, the modified data is sent to the receiver which is the second electronic device 200.

FIG. 5A is a block diagram, illustrating the content extractor 210 for extracting the ROI, according to an embodiment.

In an embodiment, the ROI detector 210 determines an area of digital display (ROI) from each frame that needs to get a required data and also the metadata boundaries. The ROI detector 210 comprises a luminosity scanner 501 and a display identifier 502. The luminosity scanner 501 reads the luminosity of all the pixels captured in successive frames of a recorded clip.

After determining the luminosity, the display identifier 502 checks for an average luminosity of each pixel in the captured frame. A luminosity variation (ΔL) of each pixel in the subsequent frame is compared with a factor R. If the consecutive pixels are meeting the condition ΔL>R, a digital display is detected. Similarly, boundaries of a digital display are determined. If ΔL>R, then an edge is detected and if ΔL<R, no edge is detected. An example scenario is illustrated in FIG. 5B, wherein the edges are detected based on the value of ΔL.

In an embodiment, when a user is at a distance from the transmitter first electronic device 100, the second electronic device 200 smartly uses optical zoom of a camera to ensure each pixel is captured nicely in the visible light.

Thus using the ROI detector 210 coordinates of the edge of the display is detected, which is the coordinates of the region of interest.

Further, the region of interest is converted into the YCbCr format and shared with the content extractor 220.

FIG. 6A is a block diagram, illustrating the content extractor 220 for extracting desired contents, according to an embodiment.

The content extractor 220 is responsible for extracting desired content which is the augmented content in the region of interest. The content extractor 220 comprises a Cb/Cr extractor 601, a metadata reader 602 and a content re-constructor 603.

The Cb/Cr extractor 602 extracts the Cb and Cr components of all the pixels in the ROI of the successive frames of the recorded content.

After extracting the Cb and Cr components of all the pixels, the metadata reader 602 obtains the metadata of the modified data at the transmitter side. In an embodiment, the metadata is extracted by the metadata reader 222 using the Cb components of the fixed number of pixels existing at the borders of the ROI.

Further, the content re-constructor 603 interprets the modified component (Cb/Cr) of the pixels in the successive frames for the ROI based on the metadata. Further, the content re-constructor 603 converts the interpreted modified components into binary bit representing the augmented data.

FIG. 6B is a schematic diagram, illustrating examples of identification of modified content, according to an embodiment.

As seen in FIG. 6B 604 is an ith frame and 605 is the (i+1)th frame. The metadata reader 602 detects a change in the value of the Cb component from the ith frame to the (i+1)th frame. The modification factor is also determined to be 9 based on the difference. As seen the Cb component value for the ith frame is 56 and for the (i+1)th frame is 65 indicating a difference of +9.

Further, the content re-constructor 603 converts the modified components into binary bits which is 011 for the current embodiment. The content re-constructor 603 forwards the augmented data to the data selection engine 230.

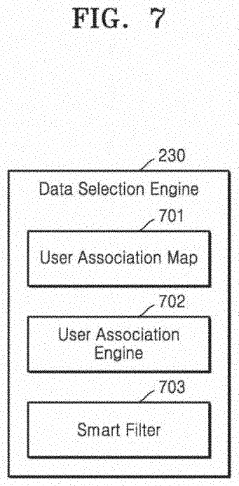

FIG. 7 is a block diagram of the data selection engine 230 for selection of the user specific data, according to an embodiment.

The data selection engine 230 is responsible for selection of the user specific data. The data selection engine 230 comprises a user association map 701, a user association engine 702, and a smart filter 703.

The user association map 701 is a map generated based on a user interaction for different context information.

The user association engine 702 assigns associative weights to different contextual weights based on the user association map 701.

Further, the smart filter 703, arranges data in decreasing order of weightage, and connects them with the possible IOT components along with their accessibility quotient.

The user specific data to be displayed is sent to the enhanced data presenter 240 by the data selection engine 230.

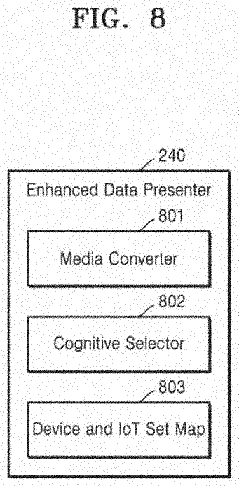

FIG. 8 is a block diagram of the enhanced data presenter 240 for selecting a display device for displaying the augmented data, according to an embodiment.

The enhanced data presenter 240 uses an appropriate display for displaying the augmented data. For example, the user is using a smartphone to capture a display, and the smartphone acquired the decoded data. Finally, the enhanced data presenter 240 plays a role to select an appropriate device to service. The device may be the smartphone or may be a smart glass or a headset.

The enhanced data presenter 240 comprises a media convertor 801, a cognitive selector 802 and a device and IOT set map 803.

The media convertor 801 selected a personalized template by the user for displaying of the augmented data. In an embodiment the media convertor 802, may select a format for displaying the augmented data according to user choice.

Further, the cognitive selector 802 selects a best possible display medium for displaying the augmented data.

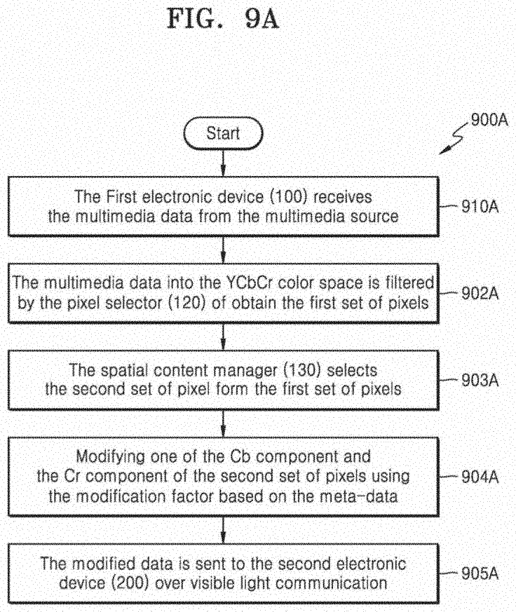

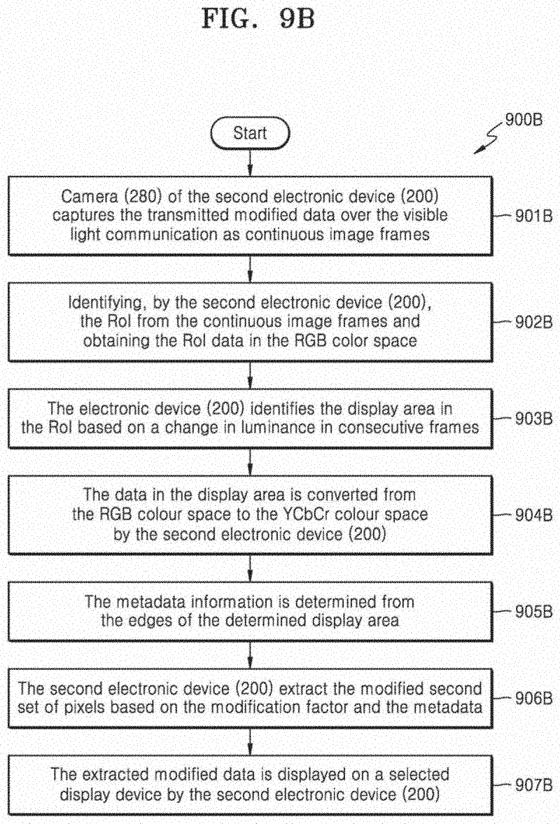

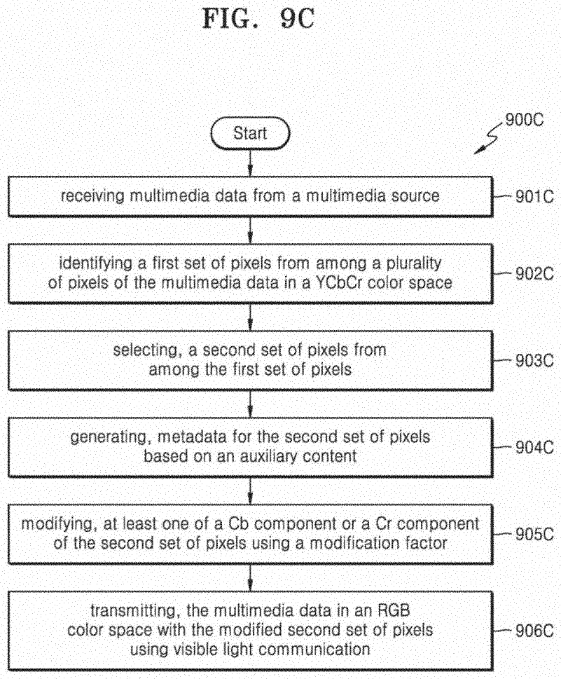

FIG. 9A is a flow diagram 900A, illustrating a method for visual content communication from a transmitter side, according to an embodiment.

At 901A, the first electronic device 100 receives the multimedia data from the multimedia source. The multimedia source may be for example be a mobile device, a display screen and the like. After receiving the multimedia data, the YCbCr convertor 110 converts the multimedia data into the YCbCr color space.

At 902A, the multimedia data converted into the YCbCr color space is filtered by the pixel selector 120 of obtain the first set of pixels. In an embodiment, the pixel selector 120 determines the information available in the plurality of pixels of the multimedia data. Further, the pixel selector 120 excludes the pixels from the multimedia data which: have both, the Cb component and Cr component outside the modulation threshold range or are part of a moving object in successive multimedia frames, or are part of an edge of an object in the multimedia data. The pixel selector 120 then compares the values of the Cb component and the Cr component for all the remaining pixels and identifies the pixels having the value of Cb component greater than the Cr component as the first set of Cb component pixel, or the pixels having the value of Cr component greater than the Cb component as a first set of the Cr component pixel.

At 903A, the spatial content manager 130 selects the second set of pixel form the first set of pixels. In an embodiment, the spatial content manager 130 determines the luminance value of each pixels in the first set of Cr component pixel and the first set of Cb component pixel. Intermediate pixels from the first set of Cr component pixel and the first set of Cb component pixel are selected having a neighboring cell with luminance value less than a threshold luminance value. Further, the second set of pixels from the intermediate pixels are selected based on the inter-pixel distance.

At 904A, the method comprises modifying one of the Cb component or the Cr component of the second set of pixels using the modification factor based on the metadata.

At 905A, the modified data is sent to the second electronic device 200 over visible light communication.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the disclosure.

FIG. 9B is a flow diagram 900B, illustrating a method for visual content communication from a receiver side, according to an embodiment.

At 901B, the camera 280 of the second electronic device 200 captures the transmitted modified data over the visible light communication as continuous image frames.

At 902B, the method discloses identifying, by the second electronic device 200, the ROI from the continuous image frames and obtaining the ROI data in the RGB color space.

At 903B, the second electronic device 200 identifies the display area in the ROI based on a change in luminance in consecutive frames.

At 904B, the data in the display area is converted from the RGB color space to the YCbCr color space by the second electronic device 200.

At 905B, the second electronic device 200 determines the metadata information from the edges of the determined display area, based on the modification factor of the modulation of one of the Cb component or the Cr component.

At 906B, the second electronic device 200 extract the modified second set of pixels based on the modification factor and the metadata.

At 907B, the extracted modified data is displayed on a selected display device by the second electronic device 200.

FIG. 9C is a flow diagram, illustrating a method 900C for visual content communication from a transmitter side, according to an embodiment. The method 900C may be performed by the first electronic device 100.

At 901C, the method 900C may include receiving multimedia data from a multimedia source.

At 902C, the method 900C may include identifying, a first set of pixels from among a plurality of pixels of the multimedia data in a YCbCr color space based on information in the plurality of pixels.

At 903C, the method 900C may include selecting, a second set of pixels from among the first set of pixels based on a luminance value and an inter-pixel distance of each pixel of the first set of pixels.

At 904C, the method 900C may include generating, metadata for the second set of pixels based on an auxiliary content, wherein the auxiliary content is to be added in the multimedia data.

At 905C, the method 900C may include modifying, at least one of a Cb component or a Cr component of the second set of pixels using a modification factor based on the metadata.

At 906C, the method 900C may include transmitting, to an electronic device the multimedia data in an RGB color space with the modified second set of pixels using visible light communication. The electronic device may be the second electronic device 200.

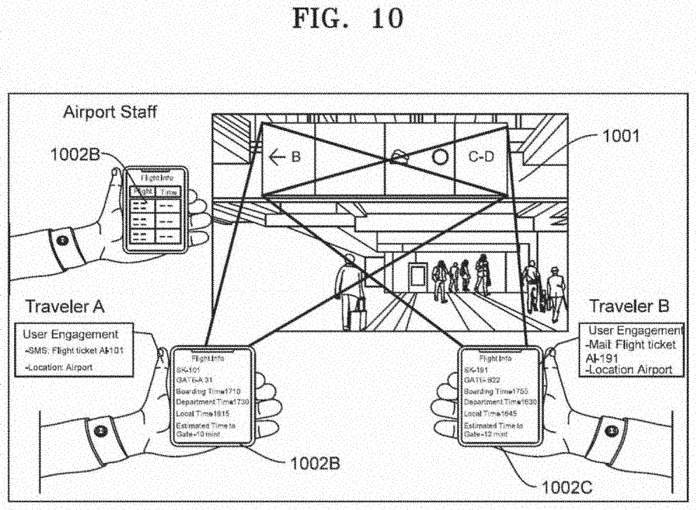

FIG. 10 is a schematic diagram, illustrating an example airport scenario of the visual light communication, according to an embodiment.

As seen in FIG. 10, a display device 1001 is displaying schedule of various flight. However, as the display device 1001 is at a height, a passenger at the airport is not able to properly view the display device 1001. In a case, the display device 1001 displays a lot of irrelevant information not required by the user.

The problem is solved by the proposed method and device, where the user may view the data of the display device 1001 on a mobile device 1002 using the visible light communication. The display device 1001 acts as the transmitter and the mobile device 1002 acts as the receiver. In the present embodiment, a camera of the mobile deice 1002 is used for capturing the data travelling through visible light which is displayed on the display device 1001.

In an embodiment, once the camera captures the data from the visible light, the mobile device 1002 determines the augmented data to be displayed. Further the mobile device 1002 evaluates a history for determining a relevant information from the augmented data for the user. Finally the relevant information is displayed on a screen of the mobile device 1002.

As may be seen in FIG. 10, 1002a is a mobile device of an airport staff and displays the information a different format as desired by the airport staff. Similarly 1002b and 1002c are mobile devices of different passengers and hence displays different information into different formats as desired by the passengers.

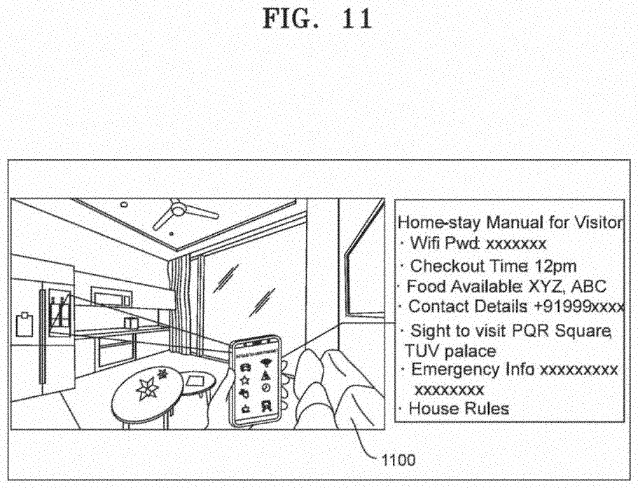

FIG. 11 is a schematic diagram, illustrating an example family hub scenario of the visual light communication, according to an embodiment.

FIG. 11 shows a smart home 1100 comprising smart (AI/IOT) devices such as a smart refrigerator, an IOT light, an IOT robot vacuum cleaner and the like. In the present embodiment, the smart home 1100 provides a home-stay facility to different travelers as guests. Usually, the guest visiting the smart home 1100 is not aware of the passwords, the house rules and other necessary information. It is difficult for the owner and or the workers to talk to each guest in person and convey the information. In such case, the proposed method provides a general instruction manual on a device of the guest, which may be augmented based on the guest requirement. As seen in FIG. 11, the guest is able to obtain a brochure comprising the desired information.

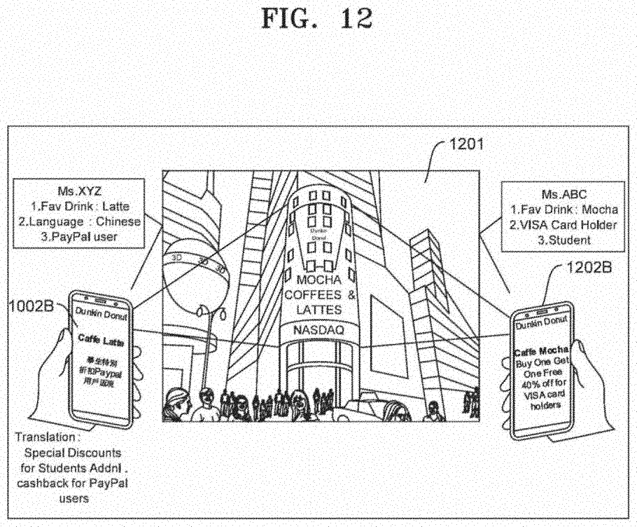

FIG. 12 is a schematic diagram illustrating an example scenario of a monument display according to an embodiment.

In the present example, the monument display 1201 is powered at a crowded place and advertises a coffee and donuts place. The monument display 1202 acts as a source of augmented information.

Any user may view the data of the monument display 1201 on personal device as seen in FIG. 12.

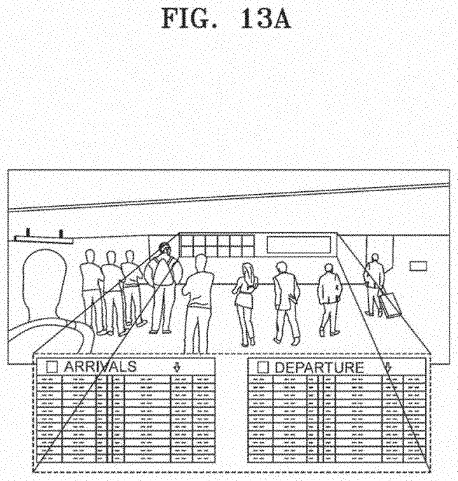

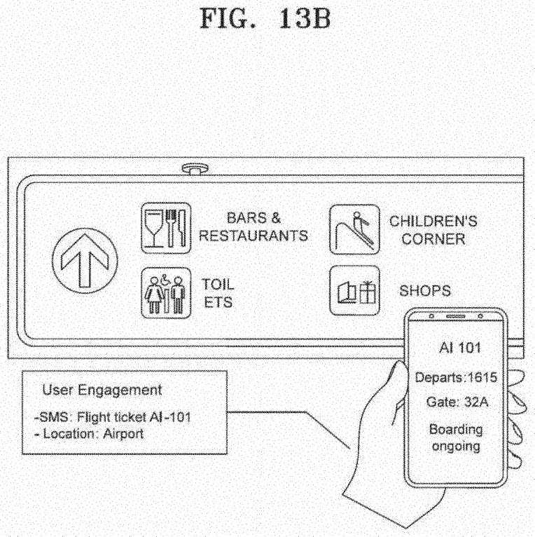

FIG. 13A is a schematic diagram illustrating problems in a display at an airport.

Airport Scenario: People have crowded at a common place in airport to know running status of their flight. Problems Faced at airport is that the relevant data is hard to spot from rapidly changing information. Other problems which may be faced are visual impairment, people cannot read from far distance. Further, overcrowding needs to be avoided in pandemic. Another problem may be a language barrier.

FIG. 13B is a schematic diagram illustrating the solution to the problem illustrated in FIG. 13A.

As seen in FIG. 13B, any digital display at airport may act as source of transmission of auxiliary data, in addition to the existing displayed data. An ordinary phone camera is used to fetch augmented information from a distance without interference. Further, based on the user profile, the user specific data is extracted and displayed.

The present solution is applicable at many places where rapidly changing information flashes on the screen. For example, train station, stock exchange etc.

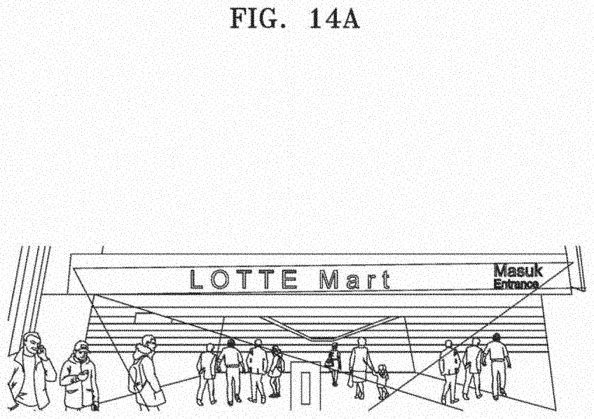

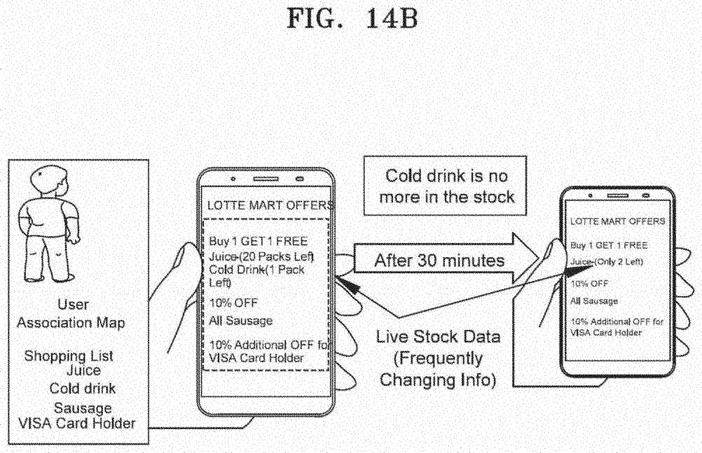

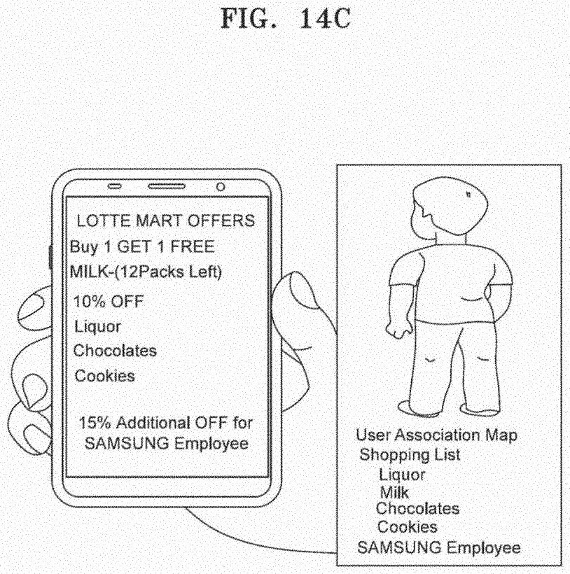

FIGS. 14A, 14B, and 14C are schematic diagrams illustrating a shopping scenario indicating different offers, according to an embodiment.

As seen in FIG. 14A, a digital display in a shopping center is illustrated. Customers coming in the shopping center, are not able to view all the information available on the digital display due to font size or dynamic change of the information. The user may not be aware of the offers and may end up buying stuff at a higher price.

The proposed solution, solves the mentioned problem. According to the present disclosure, the customer may capture the information on the digital display on the customer's mobile using light communication.

As seen in FIG. 14B, a user A is able to view the offers and other information corresponding to the item present in the user's shopping list using an association map as explained earlier. Also the user is able to get timely updates for the corresponding items. As seen after 30 minutes the cold drink stock is not available and the customer is updated due to the present solution.

Similarly, for user B, the information viewed on the customer mobile corresponds to the user's shopping list or wish list.

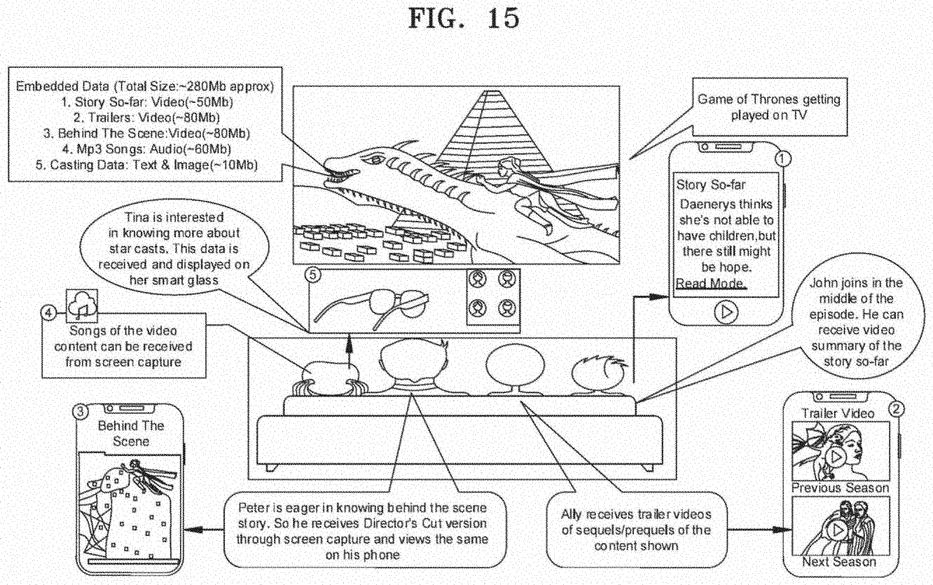

FIG. 15 is a schematic diagram, illustrating an example scenario, according to an embodiment.

FIG. 15 illustrates a scenario of providing multiple services simultaneously by various embodiments of the present disclosure. As seen in FIG. 15, few friends are watching a series on the TV. According to an aspect of the present disclosure, different recommendations may be shared, or different information may be provided to each individual based on the individual's preference.

As seen in FIG. 15, John joined late and missed earlier parts of the series and hence an embodiment of the present disclosure may share the information about the previous episodes (story so far). Similarly for Peter, director's cut version through screen capture is shown based on Peter's choice. Whereas Ally receives trailer videos of sequels/prequels of the content shown.

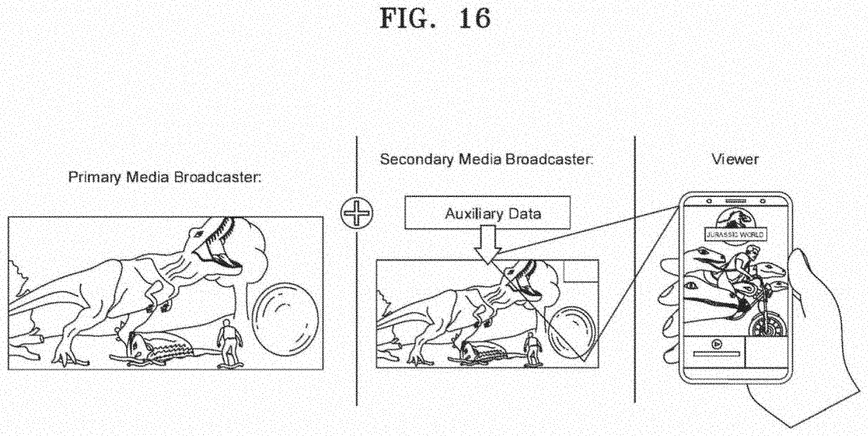

FIG. 16 is a schematic diagram, illustrating an example scenario, according to an embodiment.

As seen in FIG. 16, an original content is being displayed on a primary media broadcaster.

In an embodiment, a secondary media broadcaster augments additional information to the original content such as available sequel availability on over the top (OTT), sequel trailers, cast details and similar genre movie suggestion on the OTT. Further, the secondary broadcasting content is scanned from visual display and displayed to the user on his handheld device.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the disclosure.

The above-described embodiments may be implemented as programs executable on a computer, and be implemented by a general-purpose digital computer for operating the programs by using a non-transitory computer-readable medium. Data structures used in the above-described embodiments may be recorded on the computer-readable medium via a variety of means. The above-described embodiments of the disclosure may be implemented in the form of a non-transitory computer-readable recording medium including instructions executable by the computer, such as a program module executed by the computer. For example, methods implemented by software modules or algorithms may be stored in a computer-readable medium as computer-readable codes or program commands executable by the computer.

The non-transitory computer-readable recording medium may be any recording medium that are accessible by the computer, and examples thereof may include both volatile and non-volatile media and both detachable and non-detachable media. Examples of the computer-readable medium may include magnetic storage media (e.g., ROM, floppy disks, and hard disks) and optical recording media (e.g., compact disc-ROM (CD-ROM) and digital versatile discs (DVDs)), but are not limited thereto. Furthermore, the computer-readable recording medium may include a computer storage medium and a communication medium. A plurality of computer-readable recording media may be distributed over network-coupled computer systems, and data, e.g., program instructions and codes, stored in the distributed recording media may be executed by at least one computer.

The forgoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, those skilled in the art will recognize that the embodiments herein may be practiced with modification of the disclosure as described herein.

What is claimed is:

1. A method of visual content communication, the method comprising:
receiving multimedia data;
identifying a first set of pixels from among a plurality of pixels of the multimedia data in a YCbCr color space;
based on a luminance value and an inter-pixel distance of each pixel of the first set of pixels, selecting a second set of pixels from among the first set of pixels;
generating metadata for the second set of pixels based on an auxiliary content, wherein the auxiliary content is to be added in the multimedia data;
modifying at least one of a Cb component or a Cr component of the second set of pixels using a modification factor based on the metadata; and
transmitting to an electronic device the multimedia data in an RGB color space with the modified second set of pixels using visible light communication.

2. The method of claim 1, wherein the identifying the first set of pixels comprises:
determining information in the plurality of pixels of the multimedia data;
excluding from the multimedia data:
pixels of the multimedia data having both the Cb component and Cr component outside the modulation threshold range,
pixels of the multimedia data that are part of a moving object in successive multimedia frames, or
pixels of the multimedia data that are part of an edge of an object in the multimedia data;
comparing values of the Cb component and the Cr component for remaining pixels of the multimedia data other than the excluded pixels; and
identifying the pixels having a value of the Cb component greater than a value of the Cr component as a first set of Cb component pixels; and identifying, the pixels having the value of the Cr component greater than the value of the Cb component as a first set of Cr component pixels.

3. The method of claim 1, wherein the selecting the second set of pixels comprises:
determining the luminance value of each pixel in a first set of Cr component pixels and a first set of Cb component pixels;
selecting intermediate pixels from among the first set of Cr component pixels and the first set of Cb component pixels having a neighboring cell with a luminance value less than a threshold luminance value; and
selecting the second set of pixels from among the intermediate pixels based on the inter-pixel distance.

4. The method of claim 3, wherein the selecting the second set of pixels based on the inter-pixel distance comprises:
determining the inter-pixel distance of each intermediate pixel by checking nearest pixels in a Cr component list or a Cb component list; and
selecting a predefined number of pixels having a maximum inter-pixel distance as the second set of pixels.

5. The method of claim 1, wherein the generating the metadata for the second set of pixels comprises:
determining a plurality of information sets in the auxiliary content;
mapping pixels from the second set of pixels to the plurality of information sets in the auxiliary content; and
generating the metadata indicating the mapped pixels for the plurality of information sets, wherein the metadata includes information about pixel coordinates for each information set of the auxiliary content and the at least one of the Cb component or the Cr component to be modified.

6. The method of claim 1, wherein the modifying the at least one of the Cb component or the Cr component of the second set of pixels using the modification factor comprises:
converting the auxiliary content into binary bits;
obtaining a predefined modification factor for modifying the metadata of the second set of pixels; and
modifying the metadata of the second set of pixels by modifying one of the Cb component or the Cr component using the modification factor based on the metadata.

7. The method of claim 1, wherein the transmitting to the electronic device, the multimedia data comprises:
converting the modified second set of pixels with the YCbCr color space to the RGB color space; and
displaying the multimedia data in the RGB color space with the modified second set of pixels.

8. An electronic device for visual content communication, the electronic device comprising:
a memory storing instructions; and
at least one processor configured to execute the instructions to:
receive multimedia data, and identify a first set of pixels from a plurality of pixels of the multimedia data in a YCbCr color space based on information in the plurality of pixels,
select a second set of pixels from among the first set of pixels based on a luminance value and an inter-pixel distance of each pixel from the first set of pixels,
generate a metadata for the second set of pixels based on an auxiliary content, wherein the auxiliary content is to be added in the multimedia data,
modify a Cb component of the second set of pixels using a modification factor based on the metadata, and
transmit the multimedia data in an RGB color space with the modified second set of pixels to a display device using visible light communication.

9. The electronic device of claim 8, wherein the at least one processor is further configured to execute the instructions to:
determine the information in the plurality of pixels of the multimedia data;
exclude from the multimedia data:
pixels of the multimedia data having both the Cb component and a Cr component outside a modulation threshold range,
pixels of the multimedia data that are part of a moving object in successive multimedia frames, or
pixels of the multimedia data that are part of an edge of an object in the multimedia data;
compare values of the Cb component and the Cr component for remaining pixels of the multimedia data other than the excluded pixels, and identify pixels having a value of the Cb component greater than a value of the Cr component as a first set of Cb component pixels; and
identify pixels having the value of Cr component greater than the value of the Cb component as a first set of Cr component pixels.

10. The electronic device of claim 8, wherein the processor is further configured to execute the instructions to:
determine the luminance value of each pixel of the first set of Cr component pixels and the first set of Cb component pixels;
select intermediate pixels from among the first set of Cr component pixels and the first set of Cb component pixels having a neighboring cell with a luminance value less than a threshold luminance value; and
select, the second set of pixels from among the intermediate pixels based on the inter-pixel distance.

11. The electronic device of claim 10, wherein the processor is further configured to execute the instructions to:
determine an inter-pixel distance of each intermediate pixel by checking nearest pixels in a Cr component list or a Cb component list; and
select a pre-defined number of pixels having a maximum inter-pixel distance as the second set of pixels.

12. The electronic device of claim 8, wherein the processor is further configured to execute the instructions to:
determine a plurality of information sets in the auxiliary content;
map pixels from the second set of pixels to the plurality of information sets in the auxiliary content; and
generate the metadata indicating the mapped pixels for the plurality of information sets, wherein the metadata includes information about pixel coordinates for each information set of auxiliary content.

13. The electronic device of claim 8, wherein the processor is further configured to execute the instructions to:
convert the auxiliary content into binary bits;
obtain a predefined modification factor for modifying the metadata of the second set of pixels; and
modify the metadata of the second set of pixels by modifying one of the Cb component or the Cr component using the modification factor.

14. The electronic device of claim 8, wherein the processor is further configured to execute the instructions to:
convert the modified second set of pixels with the YCbCr color space to the RGB color space; and
display the multimedia data in the RGB color space with the modified second set of pixels.

15. A non-transitory computer-readable recording medium having recorded thereon a program for executing, the method of claim 1.

16. An electronic device, for visual content communication, the electronic device comprising:
a camera configured to capture a set of continuous image frames;
a memory storing instructions; and
a processor configured to execute the instructions to:
identify a region of interest (ROI) from the continuous image frames,
obtain the ROI data in an RGB color space,
identify a display area in the ROI based on a change in luminance in consecutive frames,
convert data in the display area from the RGB color space to a YCbCr color space, and
determine metadata information from edges of the determined display area, based on a predefined modification factor of a modulation of a Cb component, and extract a modified second set of pixels based on the modification factor and the metadata information.

17. The electronic device of claim 16, wherein the processor is further configured to execute the instructions to:
extract the Cb component and a Cr component of pixels from the ROI;
obtain the predefined modification factor;
determine a change in the Cb component and the Cr component in successive frames of the ROI based on the modification factor; and
extract the metadata information from the edges of the determined display area based on the change in the Cb component and the Cr component in successive frames of the ROI.

18. The electronic device of claim 16, wherein the processor is further configured to execute the instructions to:
generate a user association map based on a plurality of interactions of a user with a plurality of entities;
filter the modified second set of pixels to obtain user specific data based on the user association map;
select at least one format and at least one medium for displaying the user specific data; and
display the user specific data on the at least one medium.

19. The electronic device of claim 18, wherein the at least one medium is an Internet of Things (IoT) device that is selected using an IoT state map.

20. The electronic device of claim 16, wherein the processor is further configured to execute the instructions to:
identify luminance of all the pixels between successive frames;
based on the luminance and a luminance factor, detect coordinates of the ROI in successive frames.
